(19) United States
(12) Patent Application Publication
(10) Pub. No.: US 2015/0063861 A1
(43) Pub. Date: Mar. 5, 2015

(54) CLEANING DEVICE, IMAGE FORMING APPARATUS, AND METHOD FOR CLEANING

(71) Applicant: KONICA MINOLTA, INC., Tokyo (JP)

(72) Inventors: Taichi MEGURO, Tokyo (JP); Shigetaka KUROSU, Tokyo (JP); Sachie MATSUDAIRA, Tokyo (JP); Tomohide MORI, Tokyo (JP)

(21) Appl. No.: 14/472,414

(22) Filed: Aug. 29, 2014

(30) Foreign Application Priority Data
Sep. 3, 2013 (JP) 2013-181725

(51) Int. Cl. G03G 15/16

(52) U.S. Cl. CPC G03G 21/0047; G03G 15/161
USPC 399/101

(57) ABSTRACT

A cleaning device includes a semiconductive transfer member which carries charged toner; a first cleaner disposed in contact with the transfer member to electrostatically remove the toner on the transfer member; a second cleaner disposed downstream of the first cleaner along a moving direction of the transfer member to electrostatically remove the toner on the transfer member; and a voltage applicator which applies a bias voltage to the first cleaner, the bias voltage having an opposite polarity to a polarity of the toner. The bias voltage to be applied by the voltage applicator to the first cleaner is higher than a voltage which allows the first cleaner to remove maximum amount of the toner.

### CROSS REFERENCE TO RELATED APPLICATIONS

The present invention claims priority under 35 U.S.C. §119 to Japanese Application No. 2013-181725 filed Sep. 3, 2013, the entire content of which is incorporated herein by reference.

### BACKGROUND OF THE INVENTION

1. Field of the Invention

The present invention relates to a cleaning device, an image forming apparatus, and a method for cleaning.

2. Description of Related Art

An electrophotographic image forming apparatus includes an intermediate transfer belt and a secondary transfer belt to transfer toner images onto recording media. A cleaning brush and a collecting roller are used to remove the residues, such as residual toner or paper debris, attached to transfer belts, such as an intermediate transfer belt and a secondary transfer belt. The cleaning brush rotates in contact with the transfer belt to pick up and remove the residues from the surface of the belt. The collecting roller rotates in contact with the cleaning brush to remove the residues accumulated in the cleaning brush.

Unfortunately, the cleaning brush or the collecting roller cannot completely remove such residues. Some residues remain in the cleaning brush or on the transfer belt. To remove the residues in the cleaning brush or on the transfer belt, a bias voltage is generally applied. The a bias voltage applied to the cleaning brush or the collecting roller attracts positively or negatively charged residues to an oppositely charged cleaning brush or collecting roller, thereby effectively removing the residues.

In the field of production printing involving frequent transfer of a large amount of toner onto recording media, toner patterns are formed on an intermediate transfer belt to control or correct the color densities of images or a positional deviation between superimposed color images. The color densities of toner patterns are read with a photosensor to control image forming conditions based on the detected color densities. The toner on the pattern after being read with the photosensor is not transferred onto a recording medium but removed with cleaning devices disposed at an intermediate transfer belt and a secondary transfer belt, in addition to the residues on transfer belts. Thus, the production printing should remove a large amount of toner.

The removal of a large amount of toner with a cleaning device requires a high bias voltage, depending on the amount of toner. The application of a high bias voltage causes electrical discharge between the cleaning brush and the collecting roller. Such discharge causes the toner in the cleaning brush to be oppositely charged or reduces the charge of the toner, which causes the toner to remain in the cleaning brush, thus reducing the transfer efficiency of toner between the cleaning brush and the collecting roller. This leads to a filming phenomenon, that is, adhesion of discharge products originating from toner onto the surface of the cleaning brush or the collecting roller.

Another problem is a reattachment of the toner, which has passed through the contact portion between the cleaning brush and the collecting roller without being collected by the collecting roller, onto the transfer belt at the contact portion between the cleaning brush and the transfer belt due to the physical impact of the transfer belt or the effect of the electric potential of the transfer belt.

The cleaning device related techniques that address the above problems are disclosed in, for example, Japanese Unexamined Patent Application Publication No. 2012-88668.

In the patent publication, a conductive brush roller, which functions as a pre-cleaner, is disposed upstream of a cleaning device including a normally-charged-toner cleaner and an oppositely-charged-toner cleaner. Such a configuration can reduce the voltage to be applied to the oppositely-charged-toner cleaning brush for charge injection. Such a configuration solves the problem of inhibition of the charge injection by the oppositely-charged-toner cleaning brush.

Japanese Unexamined Patent Application Publication No. 2013-80029 discloses a cleaning device including a normally-charged-toner cleaner and an oppositely-charged-toner cleaner. The cleaning device has two normally-charged-toner cleaners disposed in parallel with each other. Such a configuration eliminates the necessity of removing a large amount of toner at one time and can decrease the bias voltage to be applied to the cleaning brushes. This alleviates the stress of the discharge products on the brushes which would be caused by the application of a high bias voltage.

The Japanese Unexamined Patent Application Publication Nos. 2012-88668 and 2013-80029 disclose some residual toner not removed by the cleaning brush disposed at the upstream end and remaining on the secondary transfer belt. Unfortunately, such residual toner loses its electrical charge due to the effect of a bias voltage having an opposite polarity applied to the pre-cleaner and cannot be removed by electrostatic force. Such weakly charged toner is accumulated in the brush roller of the toner cleaning device, which results in a reduction in cleaning performance in due course.

### SUMMARY OF THE INVENTION

An object of the present invention is to provide a cleaning device, an image forming apparatus, and a method for cleaning that can reduce the amount of weakly charged toner which impairs cleaning performance.

To achieve the above-mentioned object, a cleaning device reflecting one aspect of the present invention includes a semiconductive transfer member which carries charged toner; a first cleaner disposed in contact with the transfer member to electrostatically remove the toner on the transfer member; a second cleaner disposed downstream of the first cleaner along a moving direction of the transfer member to electrostatically remove the toner on the transfer member; and a voltage applicator which applies a bias voltage to the first cleaner, the bias voltage having an opposite polarity to a polarity of the toner, wherein the bias voltage to be applied by the voltage applicator to the first cleaner is higher than a voltage which allows the first cleaner to remove maximum amount of the toner.

Preferably, the bias voltage to be applied by the voltage applicator to the first cleaner is a bias voltage such that the first cleaner removes the toner at a toner removal efficiency of 80% to 95%.

Preferably, the bias voltage to be applied by the voltage applicator to the first cleaner is a bias voltage such that toner particles having an opposite polarity to a polarity of the toner before being removed by the first cleaner account for 65% or more in a charge distribution of the toner on the transfer member between the first cleaner and the second cleaner.

Preferably, the second cleaner includes an oppositely-charged-toner cleaner to which a voltage having the same polarity as a normal polarity of the toner is applied, the oppositely-charged-toner cleaner electrostatically removing the toner having an opposite polarity to the normal polarity on the transfer member; and a normally-charged-toner cleaner to which a voltage having the opposite polarity is applied, the normally-charged-toner cleaner electrostatically removing the toner having the normal polarity on the transfer member.

Preferably, the first cleaner is a metal roller plated with metal.

Preferably, the metal plating is electroless nickel plating.

### BRIEF DESCRIPTION OF THE DRAWINGS

The above and other objects, advantages and features of the present invention will become more fully understood from the detailed description given hereinbelow and the appended drawings which are given byway of illustration only, and thus are not intended as a definition of the limits of the present invention, and wherein:

FIG. 1 is a cross-sectional view of an exemplary configuration of an image forming apparatus including a cleaning device according to the present invention;

FIG. 2 is a cross-sectional view of an exemplary configuration of a secondary transfer device;

FIG. 3 is a cross-sectional view of an exemplary configuration of a secondary transfer belt cleaning device according to the present invention;

FIG. 4 illustrates exemplary polarities of toner particles before and after passage through the pre-cleaning unit at the time of application of voltage to a pre-cleaning roller in accordance with a setting according to the present invention;

FIG. 5 illustrates exemplary polarities of toner particles before and after passage through the pre-cleaning unit at the time of application of voltage to the pre-cleaning roller in accordance with an N setting;

FIG. 6 is a graphical representation of the relationship between electric current flowing into the pre-cleaning roller and toner removal efficiency; and

FIG. 7 is a graphical representation of the charge distribution of toner sampled at different sites before and after passage through the pre-cleaning unit shown in FIGS. 4 and 5.

### DESCRIPTION OF THE PREFERRED EMBODIMENTS

The configuration of an image forming apparatus including a cleaning device according to a first embodiment of the present invention will now be described.

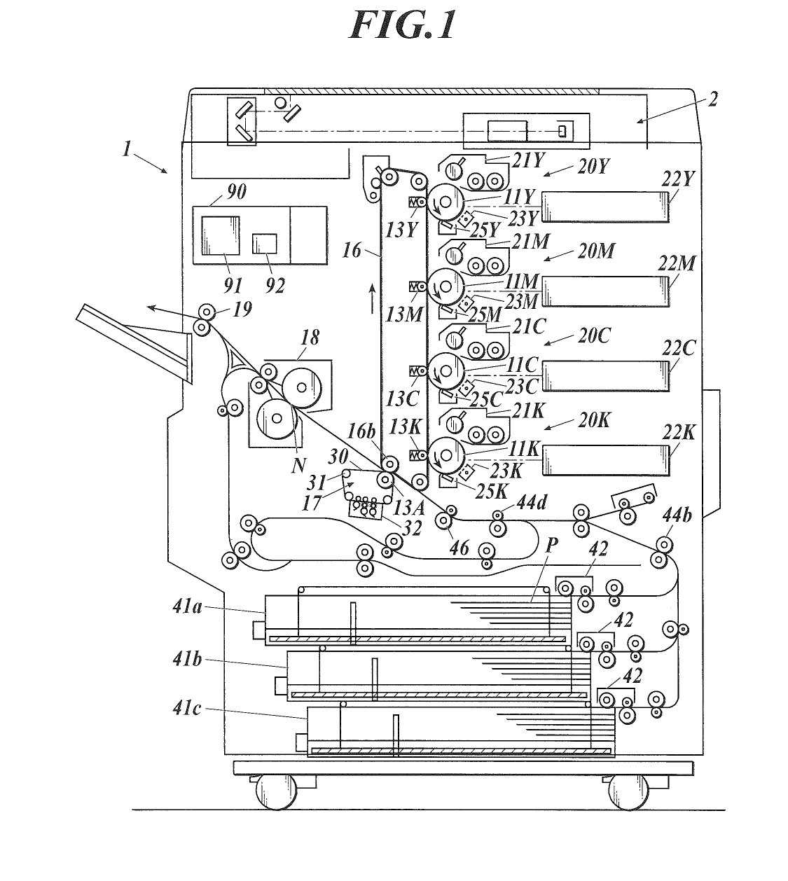

FIG. 1 is a cross-sectional overview of a configuration of the image forming apparatus 1 according to the first embodiment. The normal polarity of the toner used in this embodiment of the present invention is negative.

The image forming apparatus 1 shown in FIG. 1, which is also referred to as a tandem color image forming apparatus, includes four image forming units to form a color image. The image forming apparatus 1 forms image data on a recording medium sheet through an electrophotographic imaging process.

The image forming apparatus 1 includes four image forming units to form a color image. The four image forming units consist of an image forming unit 20Y forming a yellow (Y) image, an image forming unit 20M forming a magenta (M) image, an image forming unit 20C forming a cyan (C) image, and an image forming unit 20K forming a black (K) image.

The image forming unit 20Y includes a photoreceptor drum 11Y functioning as an image carrier and further includes a charging section 23Y, an optical writing section 22Y, a developing device 21Y, and a photoreceptor drum cleaning device 25Y, which are disposed around the photoreceptor drum 11Y. The image forming unit 20M includes a photoreceptor drum 11M functioning as an image carrier and further includes a charging section 23M, an optical writing section 22M, a developing device 21M, and a photoreceptor drum cleaning device 25M, which are disposed around the photoreceptor drum 11M. The image forming unit 20C includes a photoreceptor drum 11C functioning as an image carrier and further includes a charging section 23C, an optical writing section 22C, a developing device 21C, and a photoreceptor drum cleaning device 25C, which are disposed around the photoreceptor drum 11C. The image forming unit 20K includes a photoreceptor drum 11K functioning as an image carrier and further includes a charging section 23K, an optical writing section 22K, a developing device 21K, and a photoreceptor drum cleaning device 25K, which are disposed around the photoreceptor drum 11K. The photoreceptor drums 11Y, 11M, 11C, and 11K, the charging sections 23Y, 23M, 23C, and 23K, the optical writing sections 22Y, 22M, 22C, and 22K, and the photoreceptor drum cleaning devices 25Y, 25M, 25C, and 25K of the image forming units 20Y, 20M, 20C, and 20K have identical functions. The reference symbols Y, M, C, and K are used only if these units or sections are individually referred.

The image formation according to the first embodiment involves use of an intermediate transfer belt 16 and a secondary transfer belt 30 as transfer members.

The intermediate transfer belt 16 is an endless belt that is laid over and supported by multiple rollers in such a way as to travel around the rollers. Yellow, magenta, cyan, and black toner images formed at the image forming units 20Y, 20M, 20C, and 20K, respectively, are sequentially transferred by primary transfer sections 13Y, 13M, 13C, and 13K, respectively, onto the moving intermediate transfer belt 16 to create a color image (toner image) composed of the layers of the colors (Y, M, C, and K) superimposed one on another on the intermediate transfer belt 16.

A sheet conveying roller 44b carries a sheet P. The sheet P, which is loaded in a sheet tray 41a, 41b, or 41c, is picked up by a sheet feeder 42, and carried to a secondary transfer device 17 via a loop forming roller 44d and a register roller 46. The secondary transfer device 17 transfers the color image formed on the intermediate transfer belt 16 onto the sheet P. The sheet P having a color image transferred thereon is pressurized with heat at a nip part N of a fixing device 18 during which the toner image is melted and fixed on the sheet P. The sheet P is delivered the exterior of the device through a sheet output roller 19.

The secondary transfer device 17 is disposed in contact with a counter secondary transfer roller 16b via the intermediate transfer belt 16. The secondary transfer device 17 includes a plurality of drive rollers 31 that allow the secondary transfer belt 30 to travel around the drive rollers. The sheet P passes though the nip part between the secondary transfer belt 30 of the secondary transfer device 17 and the intermediate transfer belt 16 to transfer a toner image from the intermediate transfer belt 16 to the sheet P.

A secondary transfer belt cleaning device 32 (hereinafter referred to as merely “cleaning device”) is disposed in contact with the secondary transfer belt 30 of the secondary transfer device 17 to remove residual toner or paper debris attached to the secondary transfer belt 30.

The image forming apparatus 1 includes a voltage applicator that applies a bias voltage to the drive rollers 31 of the secondary transfer device 17 and to the cleaners of the cleaning device 32. The cleaning device 32 will be described in detail later.

The units and sections in the image forming apparatus 1 are connected to and controlled by a controller 90. A storage section 91 in the controller 90 contains programs for image formation processing. The functions of the units and sections in the image forming apparatus 1 are implemented by the respective programs, which are executed by a CPU 92 included in the controller 90.

The image forming apparatus 1 may include any component other than those mentioned as above. Alternatively, the units and sections may be partially removed from the image forming apparatus 1.

An electrophotographic process in the image forming apparatus 1 that forms an image on the sheet P will now be described.

A document is placed on a document table. The placed document is scanned while exposed to light by an optical system of an exposing scanner of an image reader 2, read by a line image sensor, and photoelectrically converted. During the photoelectric conversion, image information signals are generated for each color. The image information signals undergo analogue processing, A/D conversion, shading correction, and image compression in an image processor (not shown). The processed signals for each color are sent to the corresponding optical writing section 22 of the image forming unit 20.

The optical writing section 22 of the image forming unit 20 writes in the image information signals on the photoreceptor drum 11 to form a latent image on the photoreceptor drum 11 based on the image information signals. More specifically, the photoreceptor drum 11 includes a photoreceptor layer composed of an organic photoconductor on a metal substrate. The surface of the photoreceptor drum 11 is charged with ions generated by the charging section 23 which include a corona discharge electrode of a scorotron type, for example. The optical writing section 22 scans the photoreceptor drum 11 while exposing it with light based on the image information signals. The portions exposed to light of the charged photoreceptor drum 11 have a reduced electric potential and an electrostatic latent image corresponding to the image information signals is formed on the photoreceptor drum 11. The developing device 21 develops the electrostatic latent image on the photoreceptor drum 11 with the toner by electrostatic force to form a toner image in the corresponding color.

The toner used to develop the latent image is charged with the same polarity as the photoreceptor drum 11. For example, the photoreceptor drum 11 is negatively charged. Negatively charged toner is attached to only portions having a potential reduced by the optical writing section 22 of the latent image on the negatively charged photoreceptor drum 11, to electrostatically develop the toner image on the photoreceptor drum 11. The toner image on the photoreceptor drum 11 is transferred onto the intermediate transfer belt 16 to form an image on the intermediate transfer belt 16. Such primary transfer of the negatively charged toner onto the intermediate transfer belt 16 can be achieved by positively charging the intermediate transfer belt 16. The toner image formed on the intermediate transfer belt 16 can be transferred onto the sheet P at a nip part between a secondary transfer roller 13A and the counter secondary transfer roller 16b. Such secondary transfer of the negatively charged toner onto the sheet P can be achieved by negatively charging the intermediate transfer belt 16 from the counter secondary transfer roller 16b, which faces the secondary transfer roller 13A via the intermediate transfer belt 16 at the nip part.

A toner pattern not transferred onto the sheet P (hereinafter referred to as “untransferred toner pattern”) is regularly formed on the intermediate transfer belt 16 to correct the printing density and the color and the position of the image. The toner to form toner patterns is also negatively charged, like the toner to electrostatically develop toner images. Such a toner pattern is formed prior to a printing operation or at a time between two sheet treatments (sheet-to-sheet interval) during a continuous printing operation.

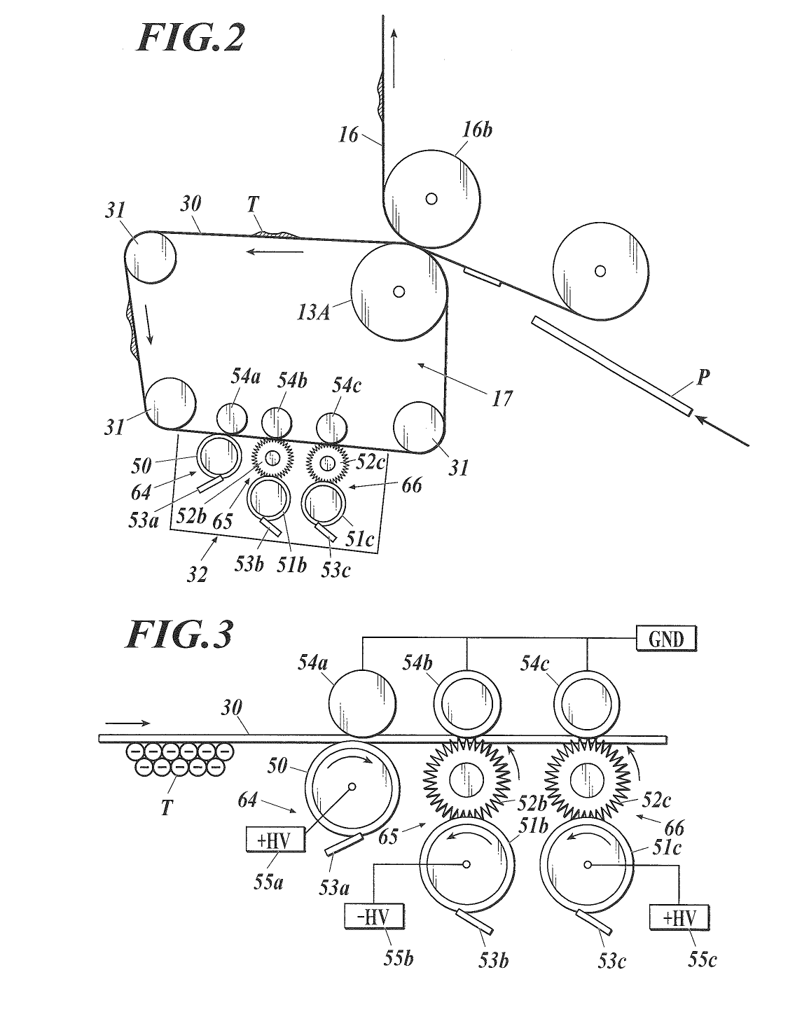

The untransferred toner pattern formed on the intermediate transfer belt 16 at the sheet-to-sheet interval is divided into an untransferred toner image remaining on the intermediate transfer belt 16 and an untransferred toner image migrated onto the secondary transfer belt 30 at the nip part between the secondary transfer roller 13A and the counter secondary transfer roller 16b, after a detector collects information on correction. Most of the untransferred toner T (see FIG. 2) is negatively charged because the toner is negatively charged as described above. The secondary transfer belt 30 holds a large amount of negatively charged toner and a relatively small amount of positively charged toner. The untransferred toner T refers to toner not transferred onto the sheet P. More specifically, the untransferred toner T refers to a large amount of toner of an image which has been formed on the intermediate transfer belt 16 for the sheet-to-sheet interval at the time of continuous printing to control the density adjustment and color deviation correction of an image and which is migrated onto the secondary transfer belt 30, but not onto the sheet P.

With reference to FIGS. 2 and 3, the configuration of the cleaning device 32 according to the first embodiment will now be described in detail.

FIG. 2 illustrates the secondary transfer device 17. FIG. 3 is an enlarged view of the configuration of the cleaning device 32 according to the first embodiment.

As shown in FIG. 2, the cleaning device 32 includes a pre-cleaning unit 64 which roughly removes the untransferred toner T from the secondary transfer belt 30; an oppositely-charged-toner cleaning unit 65 which removes the toner oppositely (positively) charged (i.e., charged with the opposite polarity to the normal polarity); and a normally-charged-toner cleaning unit 66 that removes the normally (negatively) charged toner on the secondary transfer belt 30.

The pre-cleaning unit 64 is disposed upstream of the oppositely-charged-toner cleaning unit 65 and the normally-charged-toner cleaning unit 66 along the moving direction of the secondary transfer belt 30. The pre-cleaning unit 64 includes a pre-cleaning roller 50 which removes the untransferred toner T from the secondary transfer belt 30; and a scraping blade 53a in contact with the pre-cleaning roller 50 to scrape off the toner from the surface of the roller. The pre-cleaning roller 50 is a metal roller having an outer diameter of 16 mm and having electrical conductivity to facilitate the control of discharge at or near a nip formed between the pre-cleaning roller 50 and a counter roller 54a, which faces the pre-cleaning roller 50 via the secondary transfer belt 30. The pre-cleaning roller 50 is plated with metal to increase the hardness of the pre-cleaning roller for endurance. Electroless nickel plating is particularly preferred since it provides an excellent durability and ensures a uniform plating thickness. The pre-cleaning roller 50 rotates in response to a control signal from the controller 90. The pre-cleaning roller 50 preferably rotates in the moving direction of the secondary transfer belt 30 (i.e., in the forward direction) to avoid excess torque load or friction with the belt. The cleaning device according to the first embodiment can achieve desired removal efficiency by setting a difference in the rotating speed between the secondary transfer belt 30 and the pre-cleaning roller 50 to a range of 0.8 to 1.2.

The scraping blade 53a has a tip pressed against the pre-cleaning roller 50 to mechanically scrape off the toner attached on the pre-cleaning roller 50. The scraping blade 53a may be composed of any material and have any thickness or hardness that satisfy the conditions on contact linear pressure described below. The scraping blade according to the first embodiment is in contact with the pre-cleaning roller 50 from the counter direction of the rotation direction of the pre-cleaning roller 50 in such a way that a contact linear pressure is 50 N/m to 180 N/m and that an effective contact angle is 35° to 45°, thus achieving satisfactory scraping performance.

The counter roller 54a is a semi-conductive roller having an outer diameter of 16 mm and composed of a metal core and an elastic layer therearound in view of nip part stability. An urging spring (not shown) presses the counter roller 54a with a predetermined pressure, for example, 9 N/m, towards the secondary transfer belt 30 so that the counter roller 54a comes into contact with the secondary transfer belt 30. The elastic layer is composed of a rubber or elastomer material, such as EPDM or urethane. The elastic layer may be composed of any material having predetermined electric characteristics. The elastic layer according to the first embodiment is composed of EPDM and has a resistance value of 3 log Ω to 6 log Ω to achieve a desired toner removal. The counter roller 54a is connected to the ground. To achieve a desired removal efficiency, the position of a nip formed between the pre-cleaning roller 50 and the counter roller 54a via the secondary transfer belt 30 is determined as follows: the hypothetical line perpendicular to the tangent line between the secondary transfer belt 30 and the pre-cleaning roller 50 is extended from the center of the pre-cleaning roller 50, and the center of the counter roller 54a is moved horizontally away from the extended line by 1 mm to 3 mm in the downstream direction of the secondary transfer belt 30.

As shown in FIG. 3, most of the toner constituting the untransferred toner images is normally (negatively) charged. The voltage applicator 55a outputs a bias voltage (+HV) having an opposite polarity to the polarity of the negatively charged toner to the pre-cleaning roller 50. This allows the pre-cleaning roller 50 to electrostatically attract the residual substance, such as negatively charged toner, on the secondary transfer belt 30.

The values of the bias voltage (+HV) to be applied to the pre-cleaning roller 50 are preliminarily stored in a data table in the storage section 91 in the controller 90. The data table includes the relationship between the pre-cleaning current necessary to remove toner at the pre-cleaning roller 50 and the toner removal efficiency. The data table includes multiple table subsets, which can be selected depending on, for example, environmental conditions and image forming conditions. The pre-cleaning bias voltage that provides a necessary pre-cleaning current is determined based on an appropriate data table subset. The toner removal efficiency refers to the ratio of the amount of the toner removed by the pre-cleaning roller 50 to the amount of the untransferred toner migrated onto the secondary transfer belt 30 after the secondary transfer.

The oppositely-charged-toner cleaning unit 65 is disposed downstream of the pre-cleaning unit 64 along the moving direction of the secondary transfer belt 30, and includes a cleaning brush assembly 52b that electrostatically removes the toner charged with the opposite (positive) polarity to the normal polarity of toner. A counter roller 54b facing the cleaning brush assembly 52b via the secondary transfer belt 30 pushes the secondary transfer belt 30 towards the cleaning brush assembly 52b. The cleaning brush assembly 52b comes into contact with the pushed portion of the secondary transfer belt 30. The counter roller 54b is connected to the ground. The oppositely-charged-toner cleaning unit 65 includes a collecting roller 51b and a scraping blade 53b. The collecting roller 51b collects the oppositely charged toner attached to the cleaning brush assembly 52b. The scraping blade 53b scrapes off the oppositely charged toner from the roller surface while its tip is in contact with the collecting roller 51b. The voltage applicator 55b applies a bias voltage (−HV), which has the same polarity as the normal polarity of the toner (i.e., negative polarity), to the collecting roller 51b. Such a bias voltage is applied to the cleaning brush assembly 52b via the collecting roller 51b. This allows the cleaning brush assembly 52b to electrostatically remove the residual substance, such as oppositely (positively) charged toner, remaining on the secondary transfer belt 30.

The normally-charged-toner cleaning unit 66 is disposed downstream of the oppositely-charged-toner cleaning unit 65 along the moving direction of the secondary transfer belt 30 and includes a cleaning brush assembly 52c that electrostatically removes the normally (negatively) charged toner. A counter roller 54c which is disposed to face the cleaning brush assembly 52c via the secondary transfer belt 30 pushes the secondary transfer belt 30 towards the cleaning brush assembly 52c. The cleaning brush assembly 52c comes into contact with the pushed portion of the secondary transfer belt 30. The counter roller 54c is connected to the ground. The normally-charged-toner cleaning unit 66 includes a collecting roller 51c and a scraping blade 53c. The collecting roller 51c collects the normally charged toner attached to the cleaning brush assembly 52c. The scraping blade 53c scrapes off the normally charged toner from the roller surface while its tip is in contact with the collecting roller 51c. The voltage applicator 55c applies a bias voltage (+HV), which has an opposite polarity to the normal (negative) polarity of toner, to the collecting roller 51c. Such a bias voltage is applied to the cleaning brush assembly 52c via the collecting roller 51c. This allows the cleaning brush assembly 52c to electrostatically remove the residual substance, such as negatively charged toner, remaining on the secondary transfer belt 30.

The cleaning brush assemblies 52b and 52c each include a core metal and a brush disposed therearound. More specifically, the cleaning brush assemblies 52b and 52c are fabricated as follows: the brush is made by incorporating conductive brush fibers in a conductive base cloth; and the brush is wound about a core metal and bonded to the core metal in a conductive manner. The cleaning brush assemblies 52b and 52c each advance into the secondary transfer belt 30 by 1 mm. A driver (not shown) causes the brush to rotate in such a way that the brush moves in the opposite direction (or counter direction) to the moving direction of the secondary transfer belt 30 at the contact portion. The movement of the brushing fibers in the counter direction at the contact portion can enlarge a difference in linear velocity between the cleaning brush assemblies 52b and 52c and the secondary transfer belt 30. Such an enlarged difference increases the probability for the secondary transfer belt 30 to come into contact with the brushing fibers when the secondary transfer belt 30 passes through the contact portions with the cleaning brush assembly 52b and with the cleaning brush assembly 52c. This can achieve efficient removal of toner from the secondary transfer belt 30.

The collecting rollers 51b and 51c are each a cylindrical metal roller having an outer diameter of 16 mm. The rollers of the cleaning device 32 are composed of electroless nickel plated carbon steel for machine structural use (S2OC). The collecting rollers 51b and 51c are disposed such that part of their external surfaces comes into contact with the brushing fibers of the cleaning brush assemblies 52b and 52c, respectively. The collecting rollers 51b and 51c rotate in the same direction as the cleaning brush assemblies 52b and 52c in response to a signal from the controller 90.

The cleaning brush assemblies 52b and 52c may be composed of, for example, nylon, polyester or acrylic resin. Alternatively, the cleaning brush assemblies 52b and 52c may be composed of any combination of these two or more resins.

The scraping blades 53b and 53c each have a tip pressed against collecting rollers 51b and 51c, respectively, to mechanically scrape off the toner attached to the collecting rollers 51b and 51c, respectively, like the scraping blade 53a pressed against the pre-cleaning roller 50.

The secondary transfer belt 30 may be composed of any semiconductive material having any thickness and hardness. The semiconductivity indicates a volume resistivity of 3 log Ω·cm to 12 log Ω·cm. The secondary transfer belt 30 according to the first embodiment is an elastic belt having a volume resistivity of 8 log Ω·cm to 11 log Ω·cm.

The cleaning operation of the cleaning device 32 according to the first embodiment of the present invention will now be described.

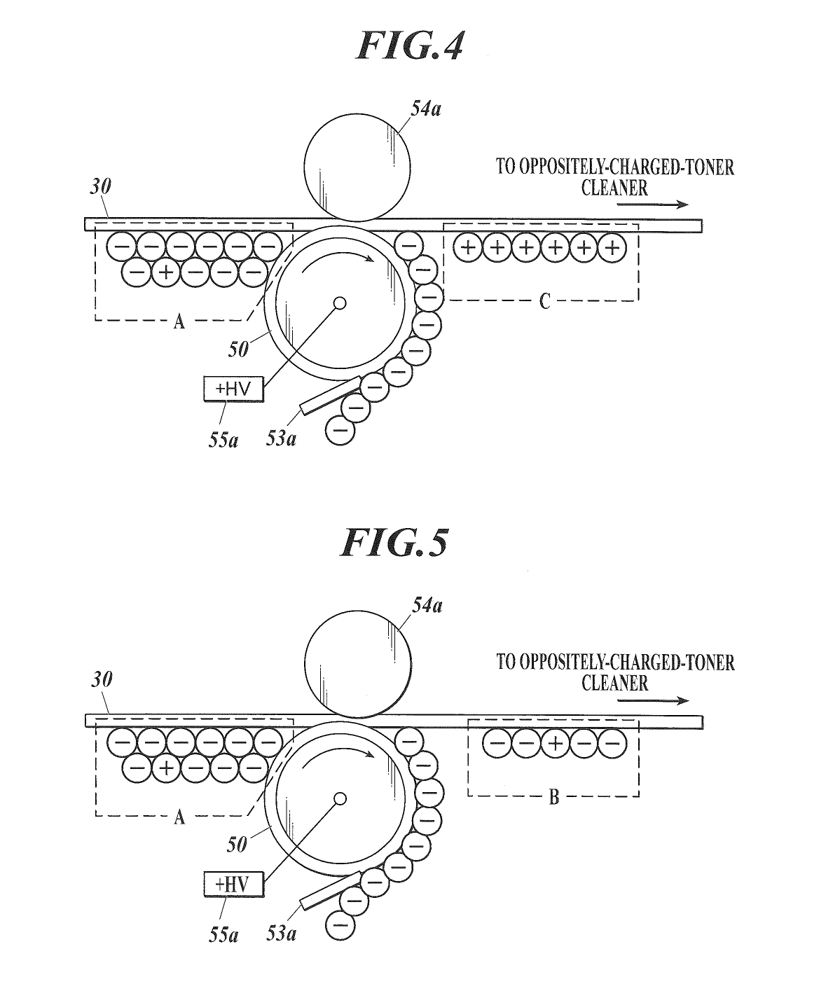

FIG. 4 illustrates the polarity of the untransferred toner T before and after passage through the pre-cleaning unit 64 at the time of application of a bias voltage according to the first embodiment of the present invention to the pre-cleaning roller 50.

As shown in FIG. 2, the untransferred toner T migrated to the secondary transfer belt 30 at the secondary transfer roller 13A is carried to the pre-cleaning roller 50 by the rotation of the drive rollers 31. As shown in the area A in FIG. 4, most of the untransferred toner T carried to the pre-cleaning unit 64 is normally (negatively) charged. Thus, most of the negatively charged toner reaching the vicinity of the nip between the pre-cleaning roller 50 and the counter roller 54a is electrostatically attracted to the pre-cleaning roller 50 due to a bias voltage, applied by the voltage applicator 55a to the pre-cleaning roller 50, having the opposite (or positive) polarity to that of the negatively charged toner and is removed from the secondary transfer belt 30. The negatively charged toner migrated onto the pre-cleaning roller 50 is scraped off with the scraping blade 53a.

Some of the particles of the untransferred toner T to which an opposite-polarity bias voltage has been applied at the pre-cleaning roller 50 are oppositely (positively) charged. Such oppositely charged toner particles, which electrostatically repel the pre-cleaning roller 50, are not removed and remain on the secondary transfer belt 30, as shown in the area C in FIG. 4.

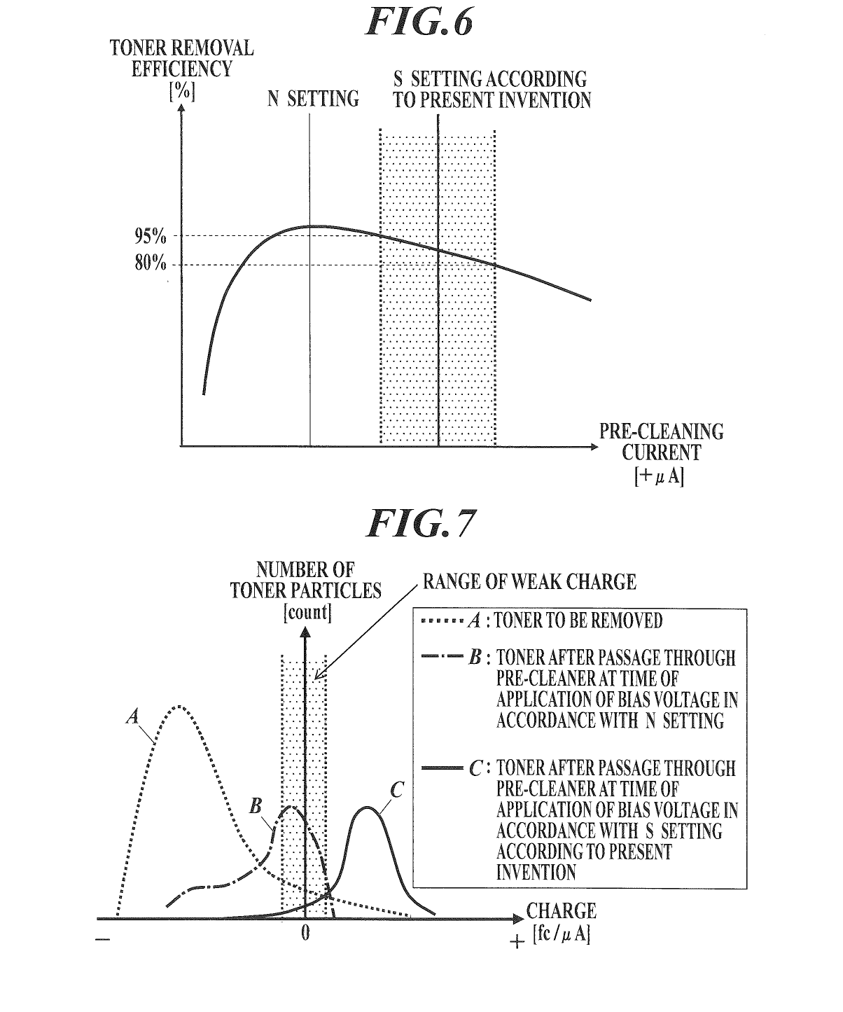

A method for determining a voltage to be applied to the pre-cleaning roller 50 will now be described with reference to FIG. 6.

The voltage to be applied to the pre-cleaning roller 50 is determined based on, for example, a data table of a toner removal efficiency curve, as shown in FIG. 6. The data table is preliminarily stored in the storage section 91. Normally, an N setting having the highest toner removal efficiency would be used. However, the cleaning device according to the present invention uses an S setting which can flow more pre-cleaning current than the N setting. The S setting allows the pre-cleaning roller 50 to remove toner and oppositely charges the residual toner which cannot be removed at the pre-cleaning roller 50 at an adequate level to ensure removal of the toner at the subsequent cleaning units.

The S setting preferably provides a bias voltage based on a pre-cleaning current that can achieve a toner removal efficiency of 80% to 95% in view of a balance between toner removal and opposite charging of toner at the pre-cleaning roller 50. A toner removal efficiency of less than 80% is not preferred since it increases the amount of residual toner that has to be removed by the oppositely-charged-toner cleaning unit 65 and the normally-charged-toner cleaning unit 66, disposed downstream of the pre-cleaning unit 64, after passage thereof, and thus increases the bias voltage necessary to remove the toner. A toner removal efficiency exceeding 95% comes close to the N setting, as shown in FIG. 6. Coming close to the N setting results in more weakly charged toner in the residual toner after passage through the pre-cleaning unit 64, as described later. This would fail to achieve a good cleaning performance at the oppositely-charged-toner cleaning unit 65 and the normally-charged-toner cleaning unit 66.

With reference to FIGS. 4, 5, and 7, the charge distribution of toner before and after passage through the pre-cleaning unit 64 will now be described where a bias voltage is applied in accordance with the S and N settings.

FIG. 4 illustrates the polarity of toner particles before and after passage through the pre-cleaning unit 64 at the time of application of a bias voltage in accordance with the S setting according to the present invention, as shown in FIG. 6, to the pre-cleaning roller 50. FIG. 5 illustrates the polarity of toner particles before and after passage through the pre-cleaning unit 64 at the time of application of bias voltage in accordance with the N setting, as shown in FIG. 6, to the pre-cleaning roller 50.

FIG. 7 illustrates the charge distribution of the toner particles sampled before and after passage through the pre-cleaning unit 64, as shown in FIGS. 4 and 5. The toner charge distribution curves A, B, and C in FIG. 7 correspond to the toner samples taken from the areas A, B, and C in FIGS. 4 and 5. The charge distribution of toner particles was measured as follows: the residual toner on the secondary transfer belt 30 was sampled in an amount of 0.5 g/cm² before and after passage through the pre-cleaning unit 64, and the charge of toner particles and the distribution of the number of toner particles for the charge of toner particles were determined by an E-spart procedure.

As shown by the charge distribution curve A in FIG. 7, most of the toner sample “A”, carried onto the pre-cleaning unit 64, is normally (negatively) charged and has a high level of charge. The residual toner sample “B” represents a sample that cannot be removed at the pre-cleaning unit 64 after the application of a bias voltage to the pre-cleaning roller 50 according to the N setting having the highest toner removal efficiency. The charge distribution curve of such residual toner sample “B” has a peak within the range of the low charge of weakly charged toner. That is, weakly charged toner exists in large amounts. This results in accumulation of residual toner in the brushes of the cleaning brush assemblies 52b and 52c, which are disposed downstream of the pre-cleaning roller 50, thus failing to maintain a good cleaning performance. In contrast, the toner sample C represents a sample remaining between the pre-cleaning unit 64 and the oppositely-charged-toner cleaning unit 65 after the application, to the pre-cleaning roller 50, of a bias voltage having the opposite (positive) polarity in accordance with the S setting according to the present invention. Such toner sample C is mostly charged oppositely to the normal polarity and contains a reduced amount of weakly charged toner. The charge of the weakly charged toner ranges between ±0.2 fc/μA.

The oppositely (positively) charged toner and the normally (negatively) charged toner remaining on the secondary transfer belt 30 which cannot be removed at the pre-cleaning roller 50 are carried to the cleaning brush assembly 52b. The cleaning brush assembly 52b is charged with a voltage, applied by the voltage applicator 55b via the collecting roller 51b, of the same polarity with the normal polarity of the toner (i.e., negative polarity). An electric field generated by a difference in the surface potential between the secondary transfer belt 30 and the cleaning brush assembly 52b electrostatically attracts the oppositely (positively) charged toner on the secondary transfer belt 30 and transfers it onto the cleaning brush assembly 52b. The positively charged toner transferred onto the cleaning brush assembly 52b is collected by the collecting roller 51b, and scraped off from the surface of the collecting roller by the scraping blade 53b in contact with the collecting roller 51b from the counter direction, opposite to the rotation direction of the collecting roller 51b.

The residual toner which cannot be removed at the oppositely-charged-toner cleaning unit 65 is carried to the normally-charged-toner cleaning unit 66. Only a slight amount of residual toner is carried to the cleaning brush assembly 52c since the toner on the secondary transfer belt 30 has been mostly removed at the pre-cleaning roller 50 and the cleaning brush assembly 52b. Such toner is normally (negatively) charged. Such a slight amount of residual toner on the secondary transfer belt 30, which is carried to the cleaning brush assembly 52c, is charged with a voltage, applied by the voltage applicator 55c via the collecting roller 51c, having the opposite (positive) polarity to that of the normal polarity of toner. As a result, the negatively charged toner on the secondary transfer belt 30 is electrostatically attached to the cleaning brush assembly 52c, collected by the collecting roller 51c, and scraped off from the surface of the collecting roller by the scraping blade 53c in contact with the collecting roller 51c from the counter direction, opposite to the rotation direction of the collecting roller 51c.

The cleaning device 32 according to the first embodiment applies a bias voltage to the pre-cleaning roller 50 according to the S setting, the bias voltage having an opposite polarity to the polarity of the toner carried to the pre-cleaning roller 50. Such application of the bias voltage allows most of the toner to be removed at the pre-cleaning unit 64 and reduces the amount of toner to be carried to the oppositely-charged-toner cleaning unit 65, which is disposed downstream of the pre-cleaning unit 64. Such application can also adequately charge the residual toner which cannot be removed at pre-cleaning unit 64 and carried to the oppositely-charged-toner cleaning unit 65, to ensure removal of the toner through application of bias voltages at the oppositely-charged-toner cleaning unit 65 and the normally-charged-toner cleaning unit 66, which are disposed downstream of the pre-cleaning unit 64. This can achieve a reduction in the amount of weakly charged residual toner, which would exist in large amounts with a conventional pre-cleaning unit, after passage through the pre-cleaning unit 64, and thus effectively prevent the accumulation of toner in the cleaning brush assemblies 52b and 52c to ensure satisfactory cleaning performance.

The cleaning device 32 according to the first embodiment applies voltage only to the collecting rollers 51b and 51c. Voltage, however, may be applied additionally to the cleaning brush assemblies 52b and 52c. In this case, the voltage applied to the collecting rollers is preferably higher than that applied to the cleaning brush assemblies. Such application of voltage generates a potential difference between the cleaning brush assemblies and the collecting rollers. Such a potential difference allows the toner to be electrostatically transferred from the cleaning brush assemblies to the collecting rollers effectively through a potential gradient toward the collecting rollers.

A cleaning device according to a second embodiment will now be described.

The cleaning device 32 and the image forming apparatus 1 according to the second embodiment have the same configuration as those of the first embodiment. The cleaning device 32 according to the second embodiment applies a bias voltage to the pre-cleaning roller 50 in such a way that the toner which cannot be removed at the pre-cleaning roller 50 and remaining on the secondary transfer belt 30 between the pre-cleaning unit 64 and the oppositely-charged-toner cleaning unit 65 has a ratio of oppositely charged toner of 65% or more.

The ratio of the oppositely charged toner is defined as the ratio of the number of toner particles on the plus-charge side of the vertical axis or the axis for zero charge (corresponding to the area of the plus-charge region of the region enclosed by the distribution curve and the straight line of “particle number=0” in FIG. 7) to the number of all the sampled toner particles (corresponding to the area of the region enclosed by the distribution curve and the straight line of “particle number=0” in FIG. 7) in the charge distribution shown in FIG. 7. The charge distribution is obtained through an E-spart procedure and represents the relationship between the charge of toner particles and the distribution of the number of toner particles for the charge of toner particles, as shown in FIG. 7.

Table 1 shows the experimental results with a secondary transfer device 17, shown in FIG. 2, which includes a cleaning device 32 according to the second embodiment. More specifically, Table 1 shows the relationship between the ratio of the oppositely charged toner remaining on the secondary transfer belt 30 between the pre-cleaning unit 64 and the oppositely-charged-toner cleaning unit 65 and cleaning performance for the secondary transfer belt 30 after passage through the cleaning device 32. The ratio of the oppositely charged toner was controlled by adjusting the current flowing into the secondary transfer belt 30 at the time of application of a bias voltage to the pre-cleaning roller 50.

TABLE 1

| PRE-CLEANING | RATIO OF OPPOSITELY | |
|---|---|---|
| CURRENT | CHARGED TONER | CLEANING |
| [μA] | [%] | PERFORMANCE |
| 40 | 50 | x |
| 60 | 55 | x |
| 80 | 60 | x |
| 100 | 65 | Δ |
| 120 | 70 | Δ |
| 140 | 75 | ∘ |
| 160 | 80 | ∘ |
| 200 | 85 | ∘ |

In the experiment, toner was sampled to measure the ratio of the oppositely charged toner, and the removal state of the toner was checked on the secondary transfer belt 30 to obtain the above experiment data.

The residual toner was sampled as follows: for example, 30 sheets (size A4) were continuously fed to the image forming apparatus 1 under normal temperature and humidity conditions to form toner patterns at sheet-to-sheet intervals. The formed sheet-to-sheet interval toner patterns were migrated onto the secondary transfer belt 30 as untransferred toner T after the elapse of a certain time. The untransferred toner T on the secondary transfer belt 30 was carried to the pre-cleaning roller 50. The image forming apparatus 1 was forced to stop before the residual toner which had not been removed at the pre-cleaning roller 50 and remained on the secondary transfer belt 30 was carried to the oppositely-charged-toner cleaning unit 65. The residual toner was then sampled from the secondary transfer belt 30. After the sampling, the secondary transfer belt 30 was cleaned and the device was reset.

The experiment was repeated with the same setting of the image forming apparatus 1 to confirm the cleaning performance for the secondary transfer belt 30.

In the experiment, the pre-cleaning current was adjusted such that the ratio of the oppositely charged toner is setting values to evaluate the ratios of the oppositely charged toner and the cleaning performances for the secondary transfer belt 30 under the settings.

The “cleaning performance” in the Table 1 indicates the capability of removing the untransferred toner T on the secondary transfer belt 30 passing through the cleaning device 32. The cleaning performance was visually evaluated. Symbol represents that no toner was observed on the secondary transfer belt 30 by visual inspection. Symbol “A” represents that a practically acceptable level of toner was observed on the secondary transfer belt 30 by visual inspection. Symbol “x” represents that an impractical level of toner was observed on the secondary transfer belt 30 by visual inspection.

Table 1 evidently shows that the toner can be removed from the secondary transfer belt 30 to a practical level when the bias voltage, which is applied to the pre-cleaning roller 50, is determined in such a way that the ratio of oppositely charged residual toner on the secondary transfer belt 30 between the pre-cleaning unit 64 and the oppositely-charged-toner cleaning unit 65 is 65% or more.

The cleaning device 32 according to the first and second embodiments applies a voltage that has an opposite polarity to that of the untransferred toner T on the secondary transfer belt 30 and is higher than the voltage capable of removing maximum amount of toner at the pre-cleaning roller 50, to the pre-cleaning roller 50, which is disposed at the upstream end along the moving direction of the secondary transfer belt 30. Such application of voltage allows the pre-cleaning roller 50 to remove the toner and adequately charge the residual toner which cannot be removed at the pre-cleaning roller 50 to ensure removal of such residual toner at the oppositely-charged-toner cleaning unit 65 and the normally-charged-toner cleaning unit 66, which are disposed downstream of the pre-cleaning roller 50, thereby ensuring satisfactory cleaning performance.

Mere application of a voltage higher than the voltage capable of removing the maximum amount of toner at the pre-cleaning unit 64 to the pre-cleaning roller 50 can reduce weakly charged toner and delay the deterioration in cleaning performance, although the cleaning performance is not as high as that of the cleaning device according to the first and second embodiments.

The transfer member to be cleaned according to the first and second embodiments is the secondary transfer belt. The untransferred toner patterns according to the embodiments, for example, are formed on the intermediate transfer belt 16 to correct the printing densities or the positions of images. Such untransferred toner on the pattern is divided into one migrated onto the secondary transfer belt 30 at the nip part between the intermediate transfer belt 16 and the secondary transfer belt 30 of the secondary transfer device 17 and one remaining on the intermediate transfer belt 16. A large amount of toner remains on the intermediate transfer belt 16. The cleaning device 32 according to the first and second embodiments may be also disposed on the intermediate transfer belt.

The entire disclosure of Japanese Patent Application No. 2013-181725 filed on Sep. 3, 2013 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A cleaning device comprising:
a semiconductive transfer member which carries charged toner;
a first cleaner disposed in contact with the transfer member to electrostatically remove the toner on the transfer member;
a second cleaner disposed downstream of the first cleaner along a moving direction of the transfer member to electrostatically remove the toner on the transfer member; and
a voltage applicator which applies a bias voltage to the first cleaner, the bias voltage having an opposite polarity to a polarity of the toner, wherein
the bias voltage to be applied by the voltage applicator to the first cleaner is higher than a voltage which allows the first cleaner to remove maximum amount of the toner.

2. The cleaning device according to claim 1, wherein the bias voltage to be applied by the voltage applicator to the first cleaner is a bias voltage such that the first cleaner removes the toner at a toner removal efficiency of 80% to 95%.

3. The cleaning device according to claim 1, wherein the bias voltage to be applied by the voltage applicator to the first cleaner is a bias voltage such that toner particles having an opposite polarity to a polarity of the toner before being removed by the first cleaner account for 65% or more in a charge distribution of the toner on the transfer member between the first cleaner and the second cleaner.

4. The cleaning device according to claim 1, wherein the second cleaner includes:
an oppositely-charged-toner cleaner to which a voltage having the same polarity as a normal polarity of the toner is applied, the oppositely-charged-toner cleaner electrostatically removing the toner having an opposite polarity to the normal polarity on the transfer member; and
a normally-charged-toner cleaner to which a voltage having the opposite polarity is applied, the normally-charged-toner cleaner electrostatically removing the toner having the normal polarity on the transfer member.

5. The cleaning device according to claim 1, wherein the first cleaner is a metal roller plated with metal.

6. The cleaning device according to claim 5, wherein the metal plating is electroless nickel plating.

7. An image forming apparatus comprising a cleaning device, the cleaning device including:
a semiconductive transfer member which carries charged toner;
a first cleaner disposed in contact with the transfer member to electrostatically remove the toner on the transfer member;
a second cleaner disposed downstream of the first cleaner along a moving direction of the transfer member to electrostatically remove the toner on the transfer member; and
a voltage applicator which applies a bias voltage to the first cleaner, the bias voltage having an opposite polarity to a polarity of the toner, wherein
the bias voltage to be applied by the voltage applicator to the first cleaner is higher than a voltage which allows the first cleaner to remove maximum amount of the toner.

8. The image forming apparatus according to claim 7, wherein the bias voltage to be applied by the voltage applicator to the first cleaner is a bias voltage such that the first cleaner removes the toner at a toner removal efficiency of 80% to 95%.

9. The image forming apparatus according to claim 7, wherein the bias voltage to be applied by the voltage applicator to the first cleaner is a bias voltage such that toner particles having an opposite polarity to a polarity of the toner before being removed by the first cleaner account for 65% or more in a charge distribution of the toner on the transfer member between the first cleaner and the second cleaner.

10. The image forming apparatus according to claim 7, wherein the second cleaner includes:
an oppositely-charged-toner cleaner to which a voltage having the same polarity as a normal polarity of the toner is applied, the oppositely-charged-toner cleaner electrostatically removing the toner having an opposite polarity to the normal polarity on the transfer member; and
a normally-charged-toner cleaner to which a voltage having the opposite polarity is applied, the normally-charged-toner cleaner electrostatically removing the toner having the normal polarity on the transfer member.

11. The image forming apparatus according to claim 7, wherein the first cleaner is a metal roller plated with metal.

12. The image forming apparatus according to claim 11, wherein the metal plating is electroless nickel plating.

13. A method for cleaning comprising the steps of:
(a) carrying charged toner using a semiconductive transfer member;
(b) applying a bias voltage to a first cleaner disposed in contact with the transfer member using a voltage applicator, the bias voltage having an opposite polarity to a polarity of the toner;
(c) electrostatically removing the toner on the transfer member using the first cleaner;
(d) electrostatically removing the toner on the transfer member using a second cleaner disposed downstream of the first cleaner along a moving direction of the transfer member, wherein
the bias voltage to be applied by the voltage applicator to the first cleaner is higher than a voltage which allows the first cleaner to remove maximum amount of the toner.

14. The method for cleaning according to claim 13, wherein the bias voltage to be applied by the voltage applicator to the first cleaner is a bias voltage such that the first cleaner removes the toner at a toner removal efficiency of 80% to 95%.

15. The method for cleaning according to claim 13, wherein the bias voltage to be applied by the voltage applicator to the first cleaner is a bias voltage such that toner particles having an opposite polarity to a polarity of the toner before being removed by the first cleaner account for 65% or more in a charge distribution of the toner on the transfer member between the first cleaner and the second cleaner.

16. The method for cleaning according to claim 13, wherein step (d) includes :
electrostatically removing the toner having an opposite polarity to a normal polarity of the toner on the transfer member using an oppositely-charged-toner cleaner to which a voltage having the same polarity as the normal polarity is applied; and
electrostatically removing the toner having the normal polarity on the transfer member using a normally-charged-toner cleaner to which a voltage having the opposite polarity is applied.
